(19) United States
(12) Patent Application Publication
(10) Pub. No.: US 2008/0088151 A1
(43) Pub. Date: Apr. 17, 2008

(54) Automatic truck bed cover assembly

(76) Inventor: Armen Shagbazyan, Glendale, CA (US)

Correspondence Address: EDWIN TARVER, 16830 Ventura Blvd., SUITE 360, Encino, CA, 91436, US

(21) Appl. No.: 11/584,018

(22) Filed: Oct. 13, 2006

(51) Int. Cl. B60P 7/02

(52) U.S. Cl. 296/100.05

(57) ABSTRACT

A truck bed cover assembly installed over a truck bed comprising a plurality of rigid inverted U-shaped covers, a plurality of tracks located one below the other on sidewalls of the truck bed, two motors and two threaded shafts connected to the motors. The covers include a projecting member extending outwardly from and along the length of its free ends. The covers are of different size and form a telescopic arrangement when their projecting members are received in the tracks. The projecting members on the last cover include a threaded bore for receiving the threaded shafts. When the motors are activated, the rotary motion of the threaded shafts imparts a linear motion to the last cover, which in turn is adapted to pull or push the rest of the covers, thereby covering or uncovering the truck bed.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to truck bed accessories, and more particularly, to an automatic truck bed cover assembly for installation on a pick-up truck.

Typically, truck beds are exposed to sunlight, heat, wind, and rain, which may damage goods or cargo in it. Therefore, truck bed covers are used in order to shield and protect the cargo. A variety of structures and mechanisms have been developed to manually or automatically operate the truck bed covers for covering the truck bed area.

For example, U.S. Pat. No. 6,471,282 to Hanning discloses a retractable protective cover assembly that is installed over the tonneau of a pick-up truck. The assembly includes a pair of elongated guide tracks and rollers on each of the sides of the bed. The guide tracks are positioned in parallel formation on either side of the bed, and the rollers are located within the tracks. A plurality of frame members are in guided engagement with the rollers. Expansion brackets are secured at the top and bottom of each frame member. Preferably, the top bracket is fixed and the bottom bracket is movable along the length of the frame member. The frame members communicate with each other through linkages, which are attached to the two sides of the brackets. Upon initiating an automatic or a manual process for activating the assembly, the roller motion along the tracks causes the lower bracket of each frame member to move along the length of the frame member producing a relative displacement. The use of rollers and brackets is different from the present invention, which employs motors and threaded shafts.

U.S. Pat. No. 3,656,802 to White discloses an automatically retractable cover that is designed especially for a dump truck. The dump truck includes an inverted U-shaped member comprising a pair of arms and a cross member. The outer ends of the arms are fixed to a shaft that is pivotally mounted beneath the truck bed. A piston in a cylinder mounted beneath the truck bed has its piston rod actuated responsive to a switch within the truck. The piston rod in turn drives a crank arm that is radially attached to the shaft to pivot the inverted U-shaped member from a forward position to a rearward position. The front end of the cover is attached to a horizontal rod mounted transversely atop the forward portion of the cab protection platform of the truck bed. The back end of the cover is attached to the cross member of the inverted U-shaped member. Upon activating the piston and cylinder mechanism, the inverted U-shaped member moves forward and rearward, thereby covering and uncovering the truck bed. The structural features such as the truck bed cover and piston-cylinder mechanism are different from the present invention.

U.S. Pat. No. 6,799,787 to Angelos discloses a transformable truck bed cover to be mounted upon a pick-up truck. The cover assembly is transformable in height between a tonneau cover-like configuration and a fully elevated truck cap-like configuration, and in length between a fully retracted position and a fully extended position covering the entire length of the bed. The cover assembly generally comprises two anchoring rails fixedly attached to the sides of the truck bed, and two or more articulated cover support assemblies, extending across the bed, with an attached flexible cover assembly. The support assemblies are pivotally secured to the anchoring rails such that they may be pivoted upward to form a cap-shaped covering. The cover support assemblies are also slidably attached to the anchoring rails such that the flexible cover may be extended or retracted, in an accordion-like fashion, along the truck bed's length. Transformation between any of the various height or length configurations may be accomplished manually or automatically. Although the length transformation of this cover assembly appears to be similar, the present invention uses relatively simple truck bed covers and mechanism to automatically extend/retract the truck bed covers.

Therefore, it is an object of the present invention to provide an improved automatic truck bed cover assembly, which is relatively simple in construction and utilizes motors and threaded shafts for automatically extending and retracting the truck bed cover. Other objects of the present invention will become better understood with reference to the appended Summary, Description, and Claims.

### SUMMARY

The present invention is an automatic truck bed cover assembly. The assembly comprises a plurality of rigid and substantially inverted U-shaped truck bed covers, two low-speed DC motors and two threaded shafts, each connected to one of the motors. The free ends of a cover include a projecting member that projects outwardly along its length. The sidewalls of the cargo bed include a plurality of tracks one below the other for receiving the projecting members of the covers. In one embodiment, four covers and four tracks are used for the assembly. The covers are slightly different in size and the first, second, third, and fourth covers are received in the first, second, third, and fourth tracks, respectively, to form a telescopic configuration.

A plurality of cables are used to connect all the covers. The first cover is fixed to the truck cab while the rest can be slidably moved in the tracks. The fourth cover includes a threaded bore in its projecting members and a plurality of tail members extend outwardly from its surface. The threaded shafts are received in the threaded bore of the fourth cover.

When the motors are activated, the rotary motion of the threaded shafts imparts a linear motion to the fourth cover. While covering the truck bed, the shafts turn in one direction to extend the fourth cover, which in turn pulls the second and third covers by the cables. While uncovering the truck bed, the shafts turn in an opposite direction to retract the fourth cover. The second and third covers are pushed back towards the cab by the tail members.

### BRIEF DESCRIPTION OF THE FIGURES

FIG. 1 is an illustration of a perspective view of the truck with truck bed covers in accordance with the present invention.

FIG. 2 is an illustration of the rear view of the truck without the covers.

FIG. 3 is an illustration of the first cover, which is identical to second and third covers.

FIG. 4 is an illustration of the last cover.

FIG. 5 is an illustration of the rear view of the truck with the covers.

FIG. 6 is an illustration of the side view of the truck with the covers retracted.

FIG. 7 is an illustration of the side view of the truck with the covers extended.

FIG. 8 is an illustration of a partially broken side view of the truck showing the motor and the threaded shaft.

FIG. 9 is an illustration of the bottom view of the covers in extended condition.

### FIGURES—REFERENCE NUMERALS

10 . . . Truck
11 . . . Truck Bed
12 . . . Cab
13 . . . Bumper
14 . . . Sidewall
15 . . . Tailgate
16 . . . Track
17 . . . Inverted U-shaped Cover
18 . . . Projecting Member
19 . . . Threaded Bore
20 . . . Bolt
21 . . . Cable
22 . . . Tail Member
23 . . . Window Panel
24 . . . Water Proof Material
25 . . . Motor
26 . . . Threaded Shaft
27 . . . Hinge
28 . . . Handle on the Window Panel

### DETAILED DESCRIPTION

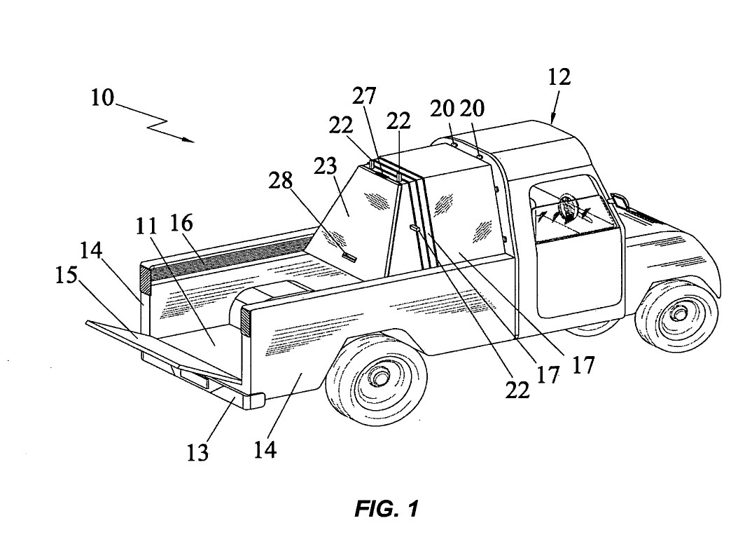

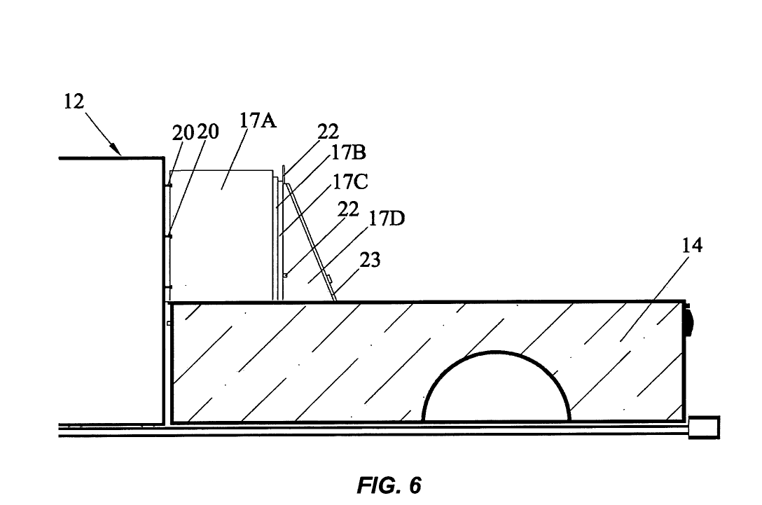

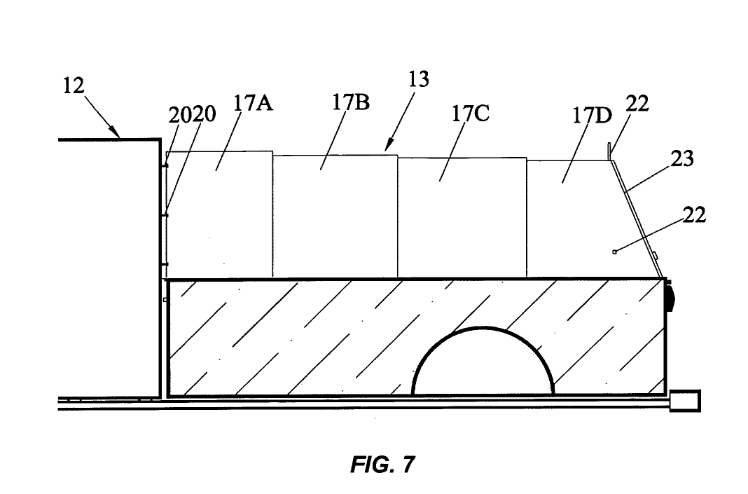

Referring to the drawings, the preferred embodiment of an automatic truck bed cover assembly is illustrated in FIGS. 1 through 10. The present invention is an assembly that can be installed on a truck 10 to cover the truck bed 11.

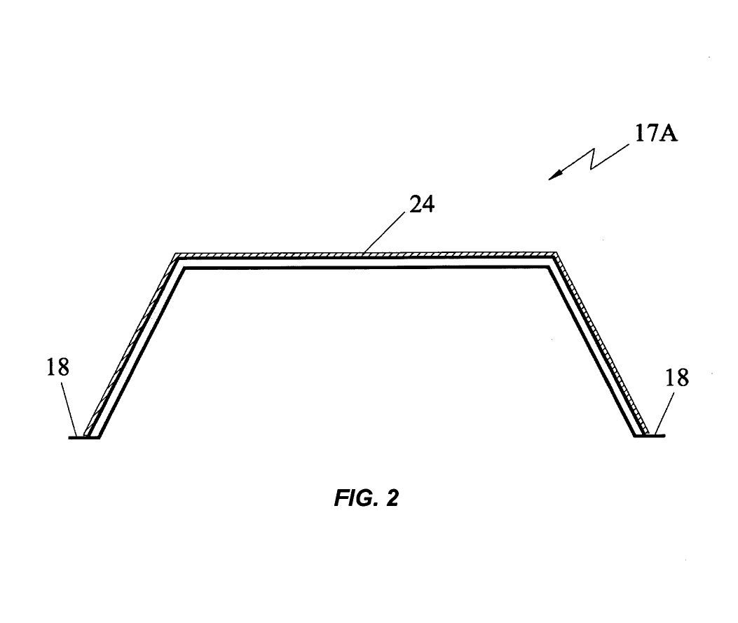

Referring to FIGS. 1 and 2, the truck 10 generally includes a cab 12 and a truck bed portion including a bumper 13, two sidewalls 14 and a tailgate 15. The interior surfaces of the sidewalls 14 include a plurality of tracks 16, one below the other. For example, four tracks, namely the first, second, third, and fourth, are located one below the other near the top portion of the sidewalls 14. The tracks 16 are in the form of longitudinal grooves.

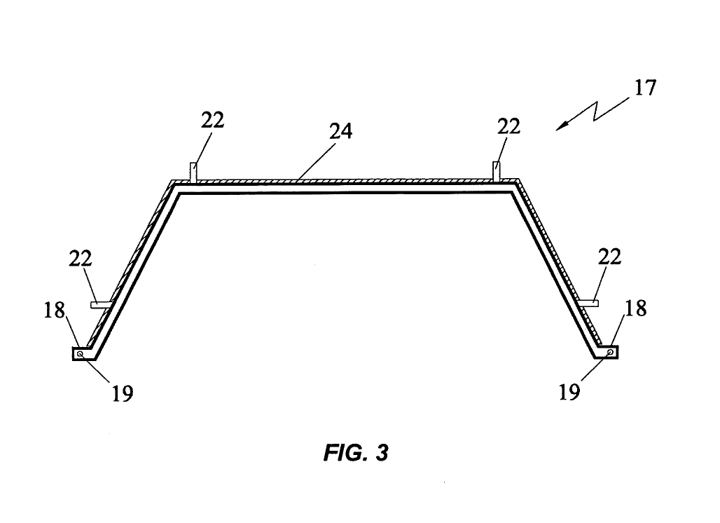

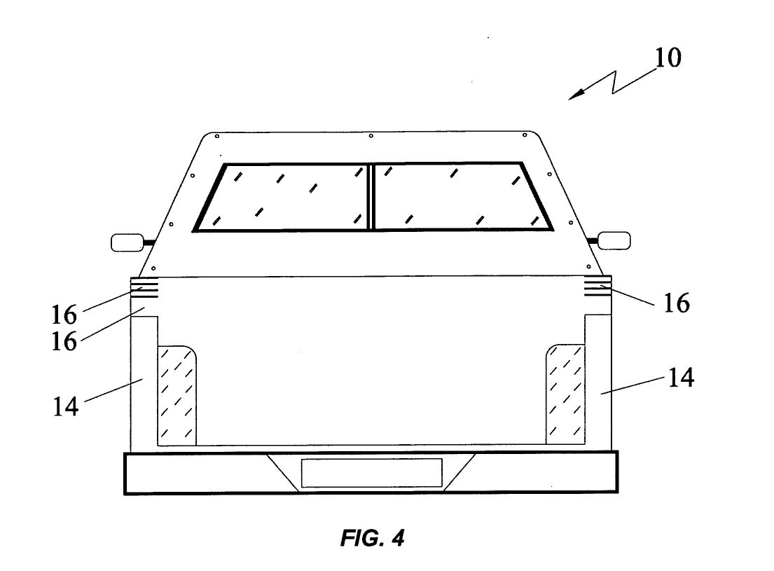

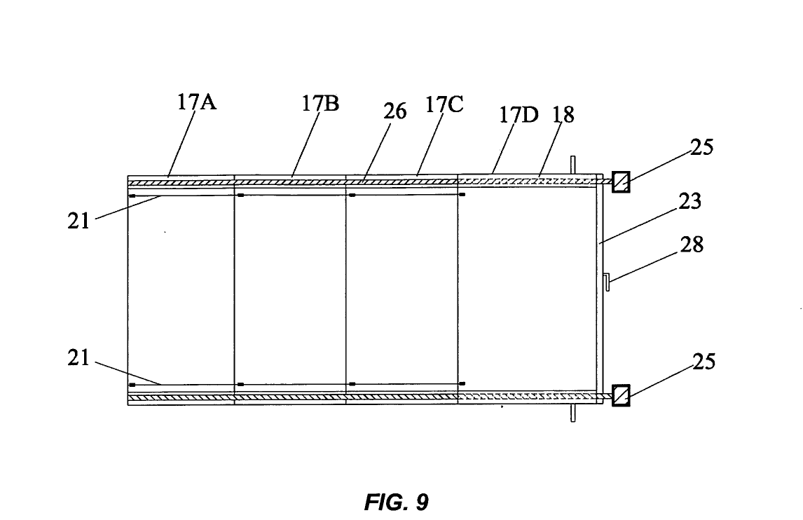

Referring to FIGS. 3 and 4, four inverted U-shaped truck bed covers 17, namely, first 17A, second 17B, third 17C, and fourth 17D, are used in the assembly. The free ends of each truck bed cover 17 include a projecting member 18 that extends along the length of the cover. The first, second, and third covers are identical, as shown in FIG. 9. The fourth cover 17D is slightly different in that it includes a threaded bore 19 in its projecting members, as seen in FIG. 10. For this reason, the projecting members on the fourth cover 17D are larger compared projecting members on the other covers. The projecting members 18 received in the tracks 16. More particularly, the projecting members 18 of the first 17A, second 17B, third 17C, and the fourth covers 17D are received in the first, second, third, and the fourth tracks 16, respectively. Alternatively, any number of covers and tracks can be selected

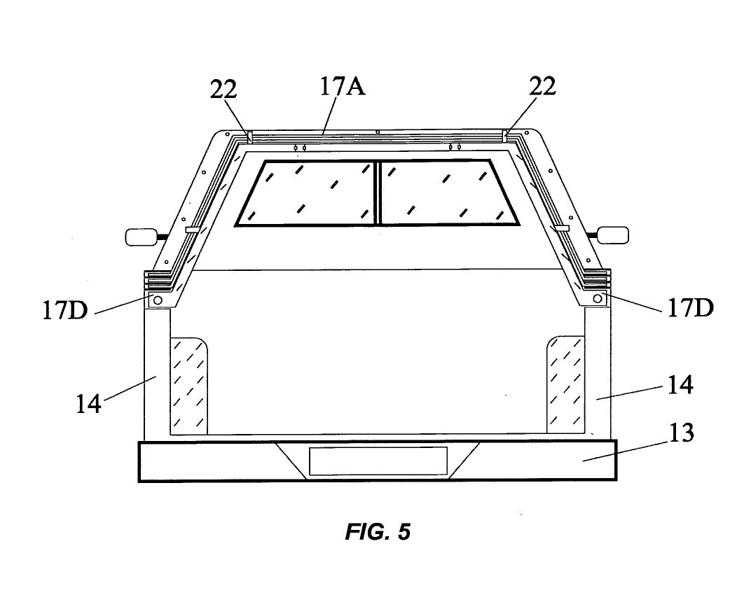

Referring to FIGS. 5 through 7, the first cover 17A is permanently attached to the rear portion of the cab 12 using suitable fasteners such as bolts 20. Two steel cables 21 are used to connect the covers 17. The fourth cover 17D includes four tail members 22, two are disposed on its top edge and the other two are located on its either side edges. A window panel 23 is connected to rear top edge of the fourth cover 17D using a hinge 27. The window panel includes a handle 28.

The covers are slightly different in size to form a telescopic arrangement when received in their respective tracks. The second cover 17B can slide below the first 17A, the third 17C below the second 17B and the fourth 17D below the third 17C, etc. The covers comprise any solid rigid material. The exterior surfaces of the covers include a lining of waterproof material 24.

Two low speed DC motors 25 are mounted near the rear end of the truck bed. A threaded shaft 26 is associated with each motor and can rotate in either direction. The motors 25 can be activated by an activation means (not shown) such as a remote control or a switch located inside the truck cab. The motor and threaded shafts are in level with the fourth track in order to be received in the threaded holes of the fourth cover 17D. When the motors 25 are activated, the rotary motion of the threaded shafts 26 imparts a linear motion to fourth cover 17D, which then slides along the fourth track.

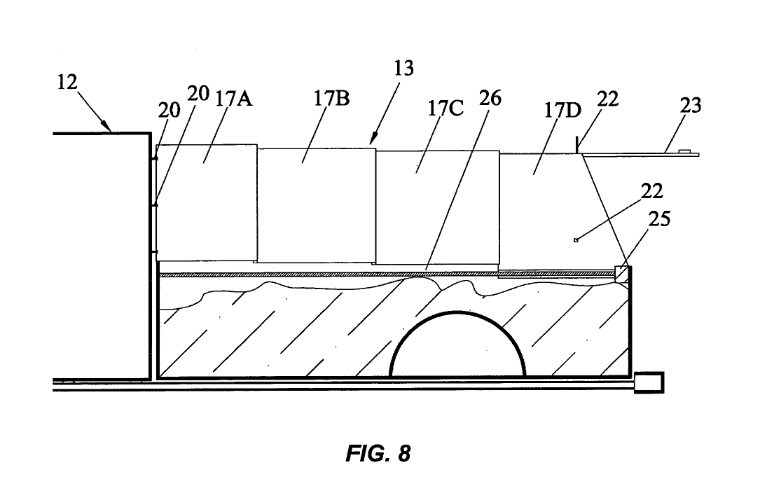

In order to extend the covers, the threaded shafts 26 are rotated. The fourth cover 17D slides and extends along the fourth track. Since all the covers are connected by steel cables 21, the fourth cover pulls the second and third cover along with it, thereby covering the truck bed area, as seen in FIGS. 8 and 9. To retract the covers, the threaded shafts are made to rotate in the opposite direction. The fourth cover 17D slides towards the truck cab and the tail members on it will push the second and third truck bed covers towards the cab, thereby uncovering the truck bed area. The motors 25 are automatically deactivated when the fourth cover 17D is fully extended or retracted. The window panel 23 is used to cover the gap between the tailgate 15 and the fourth cover 17D when the assembly is in extended condition. The direction of rotation of the threaded shafts is selected by the activation means.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A truck bed cover assembly for installation over a truck bed, the assembly comprising:
(a) a plurality of rigid inverted U-shaped covers to cover a truck bed area, the inverted U-shaped covers including a projecting member extending outwardly from and along the length of its free ends;
(b) a plurality of tracks located one below the other on the interior surfaces of sidewalls of the truck bed, each track in the form of a longitudinal groove adapted to receive the projecting member on the cover; wherein the covers are of different sizes and form a telescopic arrangement when their projecting members are received in the tracks; with a first cover fixed to the truck cab and a last cover being in connection with all the other covers;
(c) at least one motor;
(d) at least one threaded shaft connected to the at least one motor; and
(e) at least one threaded bore or hole in the last cover for receiving the at least one threaded shaft;
wherein when the at least one motor is activated, the rotary motion of the at least one threaded shaft imparts a linear motion to the last cover, which in turn is adapted to pull or push the rest of the covers, thereby covering or uncovering the truck bed.

2. The truck bed cover assembly of claim 1, wherein two motors and two threaded shafts are used in the assembly, the two threaded shafts extend along the length of the truck bed.

3. The truck bed cover assembly of claim 2, wherein each projecting member of the last cover includes the threaded bore in order to receive the threaded shafts.

4. The truck bed cover assembly of claim 2, wherein the covers are connected to each other by a plurality of cables, which facilitate in pulling the covers when the motors are activated and the assembly is covering the truck bed.

5. The truck bed cover assembly of claim 1, wherein the motors can be activated by a remote control or a switch located inside the truck cab.

6. The truck bed cover assembly of claim 1, wherein the last cover includes outwardly projecting tail members, which facilitate in pushing rest of the covers when the motors are activated and the assembly is uncovering the truck bed.

7. The truck bed cover assembly of claim 1, wherein the first cover is fixed by suitable fasteners such as bolts.

8. The truck bed cover assembly of claim 1, wherein the last cover further includes a window panel attached to its rear top edge.

9. The truck bed cover assembly of claim 1, wherein the covers are made of metal, plastic, or fiberglass.

10. The truck bed cover assembly of claim 1, wherein the covers include lining of water proof materials such as a rubber.
